(19) United States
(12) Patent Application Publication
(10) Pub. No.: US 2014/0022258 A1
(43) Pub. Date: Jan. 23, 2014

(54) METHOD TO GIVE VISUAL REPRESENTATION OF A MUSIC FILE OR OTHER DIGITAL MEDIA OBJECT USING CHERNOFF FACES

(71) Applicant: REDIGI, INC., Cambridge, MA (US)

(72) Inventor: Lawrence S. Rogel, Brookline, MA (US)

(73) Assignee: REDIGI, INC., Cambridge, MA (US)

(21) Appl. No.: 13/775,236

(22) Filed: Feb. 24, 2013

Related U.S. Application Data
(60) Provisional application No. 61/634,214, filed on Feb. 24, 2012.

(51) Int. Cl. G06T 11/20

(52) U.S. Cl. CPC G06T 11/20
USPC 345/441

(57) ABSTRACT

The invention provides in some aspects a method of visually representing a song, other creative work or other digital media object (embodying that song or other creative work) that includes generating, with digital data apparatus, a graphical depiction that algorithmically characterizes one or more properties of the song or other creative work in an image of a living thing or portion thereof. In some aspects of the invention, that living thing can be, for example, a human or other an animal, a plant or a tree. In further related aspects of the invention, that living thing or portion thereof is a cartoon or lifelike image of a human face, for example, a Chernoff face.

This claims the benefit of filing of U.S. Patent Application Ser. No. 61/634,214, filed Feb. 24, 2012, entitled “A METHOD TO GIVE VISUAL REPRESENTATION OF A MUSIC FILE USING CHERNOFF FACES,” the teachings of which are incorporated herein by reference.

### BACKGROUND OF THE INVENTION

The invention pertains to digital media handling and, more particularly, for example, to visual characterization of of digital media objects, e.g., digital files embodying creative works. The invention has application, by way of non-limiting example, to digital music, digital books, games, apps or programs, digital maps, 2D or 3D object specification files (for controlling a 3D printers), epub files and/or other directories of files (zipped into a single object or otherwise), and other digital media objects.

U.S. patent application Ser. No. 13/406,237 and corresponding PCT Patent Application Serial No. PCT/US2012/026,776 (now, Publication No. WO 2012/116365), the teachings of all of which are incorporated by reference herein, discloses inter alia methods, apparatus and systems suitable for the (re)sale or other transfer of digital media objects which methods and apparatus include, inter alia, atomically transferring ownership of those objects so that at no instant in time are copies of them available to both buyer and seller—but, rather, may be available only to the seller prior to sale and only to the buyer after sale.

Users of such apparatus and systems, may identify the works embodied in the digital media objects by way of textual titles, graphical icons and/or thumbnails of the works, as well as by “cover art” provided, e.g., by the works' respective creators and/or publishers. However, those titles, icons, thumbnails and/or cover art typically do not fully characterize the works; hence, requiring the users to “play” (e.g., playback, read, or view) samplings of the works, to read literature associated with them (e.g., album liners, or back-cover synopses), to obtain recommendations, or to use other means to identify digital media objects of interest—whether for purchase, sale, resale, lending, borrowing or other transfer or, simply, for enjoyment by listening, viewing or other playing of those media objects, all by way of non-limiting example.

While those techniques are effective, further improvements are desirable as to visual characterization of digital media objects owned, borrowed, accessed, sought or otherwise of interest to users of such apparatus or systems.

An object of this invention is to provide improved methods, apparatus and systems for characterization of creative works.

A related object is to provide such methods, apparatus and systems as facilitate the identification of digital media objects and/or creative works of interest, e.g., whether to facilitate sale or acquisition decisions or, simply, to facilitate enjoyment of them—all by way of non-limiting example.

A related object is to provide such methods, apparatus and systems as facilitate digital commerce, e.g., the (re)sale, lending, streaming or other transfer of digital music, digital books and other digital media objects.

### SUMMARY OF THE INVENTION

The foregoing are among the objects attained by the invention, which provides in some aspects a method of visually representing a song, other creative work or other digital media object (embodying that song or other creative work) that includes generating, with digital data apparatus, a graphical depiction that algorithmically characterizes one or more properties of the song or other creative work in an image of a living thing or portion thereof. In some aspects of the invention, that living thing can be, for example, a human or other an animal, a plant or a tree. In further related aspects of the invention, that living thing or portion thereof is a cartoon or lifelike image of a human face.

In related aspects of the invention, that living thing or portion thereof is a Chernoff face, and the algorithmic characterization is performed utilizing techniques applicable to such Chernoff faces as applied hereto.

Related aspects of the invention provide a method, for example, as described above, that includes generating, with the digital data apparatus, the graphical depiction of a song or digital media object embodying that song such that each of multiple acoustic properties of the song algorithmically contribute to features of the graphical depiction, e.g., of the living thing or portion thereof and, more specifically, in some aspects, of the cartoon or lifelike image of the Chernoff or other face.

Those acoustical properties can include, for example, any of: Energy Ratio, Tonality, Brightness, Energy Tempo, Energy Dry Run, Tonality Dry Run, Max Brightness, Quantized Tonality (largest Hold), Quantized Energy Ratio, Quantized Tonality, and Change Ratio. In the case of a face (such as, for example, a Chernoff face), the features contributed to by the acoustical properties can include any of slant of the eyebrows, shape of the head, distance between the eyes, and shape of the nose, all by way of non-limiting example.

Yet still other aspects of the invention provide a method, for example, as described above, that includes generating, with the digital data apparatus, the graphical depiction of the song or digital media object embodying the song such that one or more nonacoustic properties relating to the song algorithmically contribute to features of the graphical depiction. Those facial features of the graphical depiction can include, for example, those identified above, as well as, by way of non-limiting example, hair, face color and/or image color. In related aspects, the non-acoustical properties can include any of Public Image(s) of Artist, Genre, Year or Age of Song, Sex of Recording Artist(s).

The invention provides in other aspects digital data methods for generating user interfaces that include graphical depictions of songs, creative works, or digital media objects embodying such songs or creative works in accord with the methods above. Related aspects of the invention provide such methods that utilize such graphical depictions in generating any of displays, labels, and decals for packaging and other physical or electronic displays for the songs, creative works, or digital media objects embodying such songs or creative works.

Still other aspects of the invention provide e-commerce systems that provide graphical depictions of songs, creative works, or digital media objects embodying such songs or creative works in accord with the methods above.

### BRIEF DESCRIPTION OF THE DRAWINGS

A fuller appreciation of the invention and embodiments there may be attained by reference to the drawings, in which:

FIG. 1 depicts a digital data processing system and digital data devices of the type in which the invention is practiced;

FIG. 2 are graphical depictions of music files (or other digital media objects) of the type generated by systems and apparatus according to the invention;

FIG. 3 depicts a color analysis of the type performed by systems and apparatus operating in accord with the invention; and

FIG. 4 depicts a method for analyzing a digital music file in accord with invention.

### DETAILED DESCRIPTION OF THE ILLUSTRATED EMBODIMENT

### System Architecture

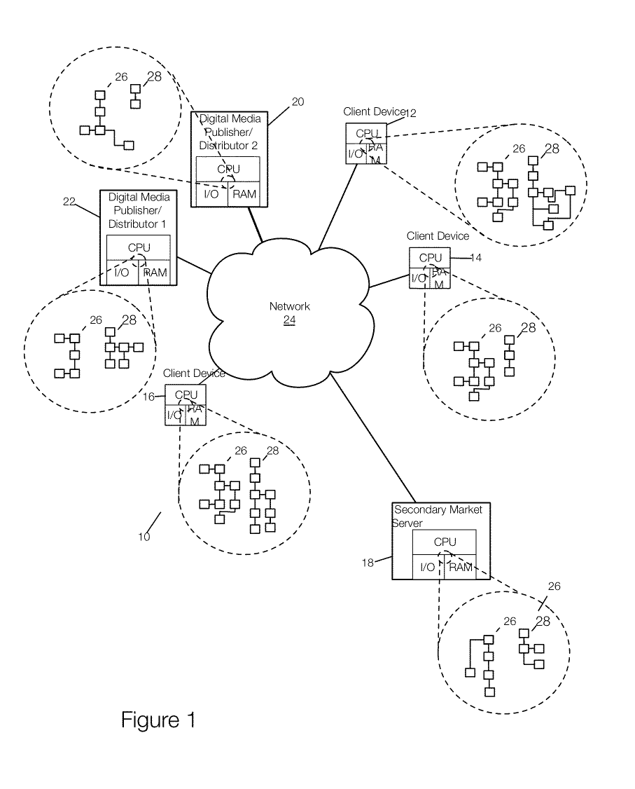

FIG. 1 depicts a plurality of digital data devices 12-22, each of the type in which the invention may be practiced. Although one or more of those devices may be stand-alone devices that operate independently of the others and sans communications with those others, here, they are depicted as forming a digital ecommerce system 10, itself, also of the type in which the invention may be practiced. Put another way, it will be appreciated that the teachings hereof can be utilized in connection with stand-alone digital data devices, as well as to systems comprising networked such devices.

By way of nonlimiting example, that system 10 includes one or more client digital data devices 12-16 and one or more server digital data devices 18-22, each comprising mainframe computers, minicomputers, workstations, desktop computers, portable computers, tablet computers, smart phones, personal digital assistants or other digital data apparatus of the type commercially available in the marketplace, as adapted in accord with the teachings hereof. As such, each of the devices 12-22 is shown as including a CPU, I/O and memory (RAM) subsections, by way of non-limiting example.

The digital data devices 12-22 may be connected for communications permanently, intermittently or otherwise by a network, here, depicted by “cloud” 24, which may comprise an Internet, metropolitan area network, wide area network, local area network, satellite network, cellular network, and/or a combination of one or more of the foregoing, as adapted in accord with the teachings hereof. And, though shown as a monolithic entity in the drawing, in practice, network 24 may comprise multiple independent networks or combinations thereof.

Illustrated client digital data devices 12-16, which are typically of the type owned and/or operated by end users, operate in the conventional manner known in the art as adapted in accord with the teachings hereof with respect to the acquisition, storage and play “digital media objects” embodying creative works, such as by way of non-limiting example, digital songs, videos, movies, electronic books, stories, articles, documents, still images, digital maps, 2D or 3D object specification files (for controlling a 3D printers), epub files and/or other directories of files (zipped into a single object or otherwise), video games, other software, and/or combinations of the foregoing—just to name a few. The client digital data devices typically comprise desktop computers, portable computers, tablet computers, smart phones, personal digital assistants or other computer apparatus of the type commercially available in the marketplace, as adapted in accord with the teachings hereof, though other devices such as mainframe computers, minicomputers, workstations may be employed as client digital data devices as well (again, so long as adapted in accord with the teachings hereof).

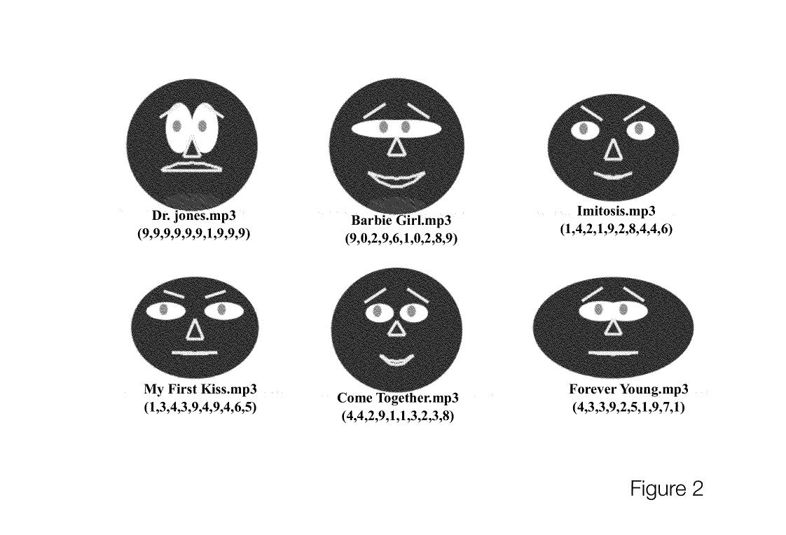

By way of further non-limiting example, client digital data devices 12-16 hereof may operate—albeit, as adapted in accord with the teachings hereof—in the manner of “computer 22” (by way of example) described in co-pending, commonly-assigned U.S. patent application Ser. No. 13/406,237, filed Feb. 27, 2012, and corresponding PCT Patent Application Serial No. PCT/US2012/026,776 (now, Publication No. WO 2012/116365), all entitled “Methods And Apparatus For Sharing, Transferring And Removing Previously Owned Digital Media” (collectively, “Applicant's Prior Applications”) and, more particularly, by way of non-limiting example, in FIGS. 2, 3A and 5 of those applications and in the accompanying text thereof.

As used herein a digital media object (or DMO) refers to a collection of bits or other digital data embodying the underlying creative work, such as, for example, a song, video, movie, book, game, digital map, 2D or 3D object specification (for controlling a 3D printers), computer app or program, just to name a few. A DMO can also embody, for example, an epub files and/or other directories of files (zipped into a single object or otherwise), by way of non-limiting example, Regardless, those bits are usually organized as a computer file, but they can be organized in other ways, e.g., in object-oriented class instances, structs, records, collections of packets, and so forth.

Illustrated server 18 is a server device of the type employed by a service operator of the type that facilitates the (re)sale, lending, streaming or other transfer of digital music, digital books or other digital media objects. By way of non-limiting example, it may operate in the manner of the ReDigi™ commercial marketplace currently operating at www.redigi.com, as adapted in accord with the teachings hereof Alternatively, or in addition, it may operate in the manner of “remote server 20” described in FIGS. 2, 3A and 5 of Applicant's Prior Applications and in the accompanying text thereof, again, as adapted in accord with the teachings hereof.

The server digital data device 18 typically comprises a mainframe computer, minicomputer, or workstation of the type commercially available in the marketplace, as adapted in accord with the teachings hereof, though other devices such as desktop computers, portable computers, tablet computers, smart phones, personal digital assistants or other computer apparatus may be employed as server 18, as well (again, so long as adapted in accord with the teachings hereof).

Servers 20-22 are server devices of the type employed by electronic music, electronic book and other digital media sellers and distributors of the type known in the marketplace, such as Amazon's same-named retail web site, Apple's iTunes website, to name just a few. In the illustrated embodiment, those servers download (e.g., upon purchase or otherwise) to devices 12-18 music files, digital books, video files, games, digital maps, 2D or 3D object specification files (for controlling a 3D printers), epub files and/or other directories of files (zipped into a single object or otherwise), and other digital media objects. Such downloads can be accomplished in the conventional manner known in the art—though, they can also be accomplished utilizing other file transfer techniques, as well. The server digital data devices 20-22 typically comprise mainframe computers, minicomputers, or workstations of the type commercially available in the marketplace, though other devices such as desktop computers, portable computers, tablet computers, smart phones, personal digital assistants or other computer apparatus may be employed as server digital data devices 20, 22, as well. In the illustrated embodiment, the servers 20, 22 are assumed be of the type commercially available and operating in the marketplace. In some embodiments, those servers are modified in accord with the teachings hereof.

Although servers 18 and 20-22 are drawn separately in the illustrated embodiment, it will be appreciated that in some embodiments their functions and that, moreover, they may be operated by a single party—for example, that serves both as a seller or distributor of digital media, as well as a service operator that facilitates the (re)sale, lending, streaming or other transfer of such media. Likewise, though shown separately, here, in some embodiments the functions of any of the client devices 12-16 may be combined with those of any of servers 18-22.

### Graphical Depictions of Digital Media Objects and Creative Works

In connection with (and/or in addition to) the operations discussed above, one or more digital data devices 12-22 operating in accord with the invention store, generate and/or otherwise provide graphical depictions of digital media objects (e.g., typically, in conjunction with the textual titles), e.g., to facilitate identification and/or manipulation of those objects. Thus, for example, software or other logic 26 executing on or in connection with one or more of those devices 12-22 can generate graphical user interfaces that permit local and/or remote users to designate digital media objects
for purchase, sale, borrowing, lending, uploading, downloading, or other transfer,
to be viewed, listened-to, or otherwise “played” (e.g., by general- or special-purpose software and/or hardware tools' (not shown) executing on or in communications coupling with those respective devices, such as, for example, MP3 players, digital book readers, video players, digital image viewers, web browsers, and so forth);
to be accessed, manipulated, and/or managed,
   all by way of nonlimiting example.

And, by way of further nonlimiting example, the software 26 of one or more of those devices 12-22 can, instead or in addition, generate graphical reports for local or remote display, printout, or otherwise that itemize digital media objects, e.g., for inventorying or other purposes. The software 26 can, as well or in addition, generate displays, labels, decals, and so forth for packaging and other physical or electronic displays pertaining to the creative works (or digital media objects).

To the foregoing ends, software 26 can form part of, comprise or be in communications coupling with web browsers (e.g., for generating user interfaces for local users), web servers (e.g., for generating user interface for remote users), general- or special-purpose applications (for local and/or remote users), all by way of non-limiting example and all of the type known in the art as adapted in accord with the teachings hereof.

According to the prior art, such graphical depictions of the digital media objects can include file extension-based icons (such as, for example, icons depicting musical notes for .WAV and .MP3 files, icons depicting a motion picture camera for .MP4 files, and so forth) or thumbnails depicting images or pages from the digital media objects. Such graphical depictions can also include reproductions of the “cover art” provided, e.g., by the underlying creative works' respective creators and/or publishers.

As noted above, however, such icons, thumbnails and/or art typically do not adequately characterize the works; hence, requiring the users to “play” (e.g., playback, read, or view) samplings of the works, to read literature associated with them (e.g., album liners, back-cover synopses), to obtain recommendations, or to use other means to identify digital media objects of interest—whether for purchase, sale, resale, lending, borrowing or other transfer or, simply, for enjoyment by listening, viewing or other playing of those media objects, all by way of non-limiting example.

Systems 10 and apparatus 12-22 operating in accord with the illustrated embodiment and, more particularly, software or other logic 28 executing on or in connection with such systems and/or apparatus, overcome shortcomings of the prior art by providing graphical depictions of creative works that algorithmically characterize each of them as function of its respective properties. As with prior art icons, thumbnails and/or art, the graphical depictions provided by systems and apparatus operating in accord with the illustrated embodiment can be used to facilitate identification and/or manipulation of digital media objects embodying those creative works, as well as to generate graphical reports that itemize digital media objects, e.g., for inventorying or other purposes, all by way of example.

Unlike prior art graphical depictions, those of software/logic 28 according to the invention algorithmically characterize the underlying creative works themselves such that each of multiple properties of the respective works contribute (e.g., solely or in combination) to realization of features of a graphical depiction of that work and such that each of multiple properties that those works have in common with other creative works are depicted in a visually perceptive comparable manner. As a consequence, those graphical depictions convey to those who view them a richer meaning of the comparative natures of those creative works—or, put another way, of a plurality of genres in which each of those works fall.

Graphical depictions of the type provided by software/logic 28, accordingly, can be used not only with graphical user interfaces that facilitate identification and/or manipulation of digital media objects, but also in other visual displays (electronic or otherwise) for the creative works. This includes not only graphical reports of the creative works (or digital media objects that embody them), but also displays, labels, decals, and so forth for advertising, point of sale, packaging and other physical or electronic displays pertaining to those works (or digital media objects). To this end, software/logic 28 can form part of, comprise and/or be communicatively coupled to software/logic 26, for generation of such user interfaces, reports, displays, labels, decals, and so forth.

Because humans are so inherently adept at recognizing faces and interpreting facial expressions, the graphical depictions provided by systems and apparatus (and more specifically, for example, by software/logic 28) operating according to preferred embodiments of the invention are faces that vary, to reiterate, in a manner that algorithmically characterize the respective creative works and, more particularly, multiple ones of their respective properties. Discussed below are examples of such embodiments in which the digital media objects are song files representing musical creative works and in which the graphical depictions are faces.

It will be appreciated, of course, that the teachings below and elsewhere herein are likewise applicable to the generation and/or other provision of such graphical depictions that algorithmically characterize other types of creative works such as books, digital maps, 2D or 3D object specification files (for controlling a 3D printers), epub files and/or other directories of files (zipped into a single object or otherwise), games, apps or programs, and/or the digital media objects that embody them, and are applicable to generation of graphical depictions of other living things or portions thereof that are readily recognized by humans—e.g., faces of animals other than humans (e.g., dogs), as well as of hands or other body parts (whether of humans or otherwise). Indeed, in some embodiments, the graphical depictions are of other living things readily recognized and is distinguished by humans, such as flowers and trees.

### Song and Digital Music File Example

### Introduction

A number of parameters can be extracted from a digital music file which can be used to generate a visual display, such as a face. Very quickly, humans are able to associate various characteristics of the music with particular features of the displayed face.

As noted above and extending thereon, artwork has traditionally been associated with commercial music, such as the image on the outside of a record album, in order to help a customer select what recording to purchase. Album art is not restricted to the cover of the package containing a phono-record. It is also used in on-line retail stores selling digital music as well as many other commercial activities involved in digital music, such as selecting a song to stream. Although for a period of time, the bulk of music was sold in album form, more recently, users have had the ability to purchase individual music tracks rather than the entire album.

It is confusing to a potential customer when all the tracks in the same album have the same associated cover art. It can be appreciated that if each music track had its own associated artwork, commercial activity associated with tracks may be improved. Up until now, it has been in the domain of the copyright holder of music or album of music to create the associated art. The copyright holder of the music has also been the copyright holder of the album cover art.

It has also been the case that the album cover art associated with a particular album is based on the fact that the owner of both decides to associate the two. There may be some deep artistic connection between the two, but that is often relevant to just the creator of the album cover art.

As the inventors of systems and apparatus operating accord with the illustrated embodiments, we believe that commerce of individual tracks of music might flourish if there is a unique visual object associated with it. In addition, it would be helpful to purchasers if the visual object had some recognizable association with the music. Since there are millions of music tracks available for purchase, at least 14 million by one recent source, manually creating a visual object with each track is a daunting task. We provide here an algorithmic way, executed by software/logic 28, for example, to generate a visual object based on various features derived from the acoustics of the music, the metadata of the song and publicly available images of the artist. Not all three are needed, of course, in all embodiments of the invention.

Humans are particularly good at recognizing faces. In fact, we are so good at it, that we can readily find similarities between several faces out of a set of thousands of samples. Humans, however, are poor at finding similarities in data especially when the similarities are in only a few dimensions from data drawn from a large dimensional space.

Prof. Herman Chernoff, a world famous statistician, came up with the idea of representing multivariate data as cartoon faces. Humans can find similarities in the faces that represent the data and map that back to similarities in the data. This representation is known as “Chernoff Faces” and has been applied in many different fields. For example, mapping college grades, standardized test scores, experience, recommendations to particular facial characteristics, and are used to quickly triage medical school applicants. They have also been used for evaluations of US judges (http://en.wikipedia.org/wiki/File:Chernoff_faces_for_evaluations_of_US_judges.svg). In these applications, each data point is divided into about a dozen values and each of these values dictates how a particular facial feature is represented—for example, the slant of the eyebrows, the shape of the head (how oval it is), the distance between the eyes, the shape of the nose, and so on.

In a related patent, U.S. Pat. No. 7,089,504, “System and Method for Embodiment of Emotive Content in Modern Text Processing, Publishing and Communication,” Chernoff faces are used to express the emotion of particular text, the teachings of which are incorporated herein by reference. Our goal is not necessarily to express emotive content and, certainly not for that alone, but rather to allow the user to associate a song with a visual image for purchases of purchase and to find similarities.

By generating or otherwise providing graphical depictions of songs or the music files that embody them in accord with the teachings hereof, potential customers will be drawn by the faces and try to match their own evaluations of the music with the faces. In systems of the sort shown, for example in FIG. 1, the faces will allow them to explore different songs to see how the faces appear. This engagement with the search process can lead to increased sales. In addition, users will begin to associate particular faces with particular songs. It ill help them rapidly find a favorite song from a long list of songs, just like it is possible to quickly find a familiar face from a large set of faces. Over time, users will be able to identify the features in the faces with the features of the songs they enjoy. This will help them find new songs. It is a visual justification of a recommendation system. In an e-commerce marketplace of the sort that may be realized in accord with FIG. 1, it visually explains to the user why a particular song was recommended to them.

### Embodiment

The sample code presented below is based to an extent on the implementation of Chernoff faces described in book Computers, Pattern, Chaos and Beauty, by Clifford Pickover, the teachings of which are incorporated herein by reference. It derives and extends from the techniques discussed there in order to algorithmically characterize the songs embodied in digital music files such that each of multiple properties (here, acoustic properties) of the respective songs contribute (e.g., solely or in combination) to features of a static image, specifically, a cartoon face depicting that respective song. As a consequence and as noted above, acoustic and other properties that those songs (and the digital media objects that embody them) have in common with other songs (and DMOs) are depicted in a visually perceptive manner that is comparable to that of the other songs. As a consequence, those graphical depictions convey to those who view them a richer meaning of the songs and the multidimensional genres in which they fall. By way of example and as a further consequence, by viewing a gallery of faces provided by software/logic 26, 28 corresponding to songs bought by a user (perhaps filtered by his or her ratings), the user may be able to spot some commonality among the faces and use this to guide future purchasing decisions.

The sample code, which can be executed by software/logic 28 and used by software/logic 26 in connection with graphical user interfaces, reports, displays, labels, decals, and so forth, makes use of ten properties derived from the acoustics of a song, by way of non-limiting example. Table 1 shows these properties. Many other properties, whether extracted from the songs (or their embodying digital media objects) or information about them (such as, titles, composer, recording artists, year of creation/publication, recording label, song popularity, and so forth) can be used instead or in addition to the ten shown below. Moreover, the software/logic 28 can algorithmically realize those song properties in the other facial features (such as color, ears, hair, cheeks, eye color, and so on) instead or in addition.

TABLE 1
Ten different properties of the acoustics of a song used,
by way of example, by software/logic 28. Each is first
computed to be normalized to a value between 0 and 1
and the quantized to a value between 0 and 9:

| | |
|---|---|
| Energy Ratio: | Songs with more “transients” and energy |
| | bursts get higher scores |
| Tonality: | Ratio 9 is a song with frames mostly tonal, 0 |
| | mostly atonal. |
| Brightness: | Spectral centroid average is high |
| Energy Tempo | Derived from “average” number of frames |
| (slow to fast): | to get a burst of energy. Loosely related to tempo. |
| Energy dry run: | Longest stretch of frames without an energy |
| | burst . . . maybe slow or boring song! |
| Tonality dry run: | Longest stretch of frames without a tonal frame. |
| | Maybe too much noise, or me singing. |
| Max Brightness: | Hum . . . something related to the max brightness |
| | seen on the song. |
| Quant. Tonality | Using quantized info for largest stretch of |
| largest Hold: | “unchanged” tonality. (a pure sine tone will get 9) |
| Quant. Energy Ratio: | Quantized energy ratio . . . |
| Quant. Tonality | Quantized tonality ratio. |
| Change Ratio: | |

Restricting ourselves to just 10 features, each with an integer value between 0 and 9, there are a total of 10,000,000,000 different faces. FIG. 2 shows six potential faces derived from six different music files. The song name is followed by the integer values corresponding to the ten music features in Table 1.

Acoustic properties of the music are not the only aspects that can used by software/logic 28 to generate a face. Additional information about them, such as properties derived from the metadata of the digital media objects that embody them can also used. Table 2 shows four such features by way of nonlimiting example—here, extracted from the metadata of the associated MP3 or other digital music file. As above, each is first normalized to a value between 0 and 1 and then quantized to a value between 0 and 9.

TABLE 2

| | |
|---|---|
| Public Images of Artist: | A search of google images, and returning the |
| | most dominant colors in all these images |
| Genre: | Symbol or color shade characterizing the |
| | particular genre of the song |
| Year: | Add a bit of Sepia tone or lack of sharpness |
| | to indicate the age of the song |
| Sex of Artist: | Male, Female, Mixed |

The software/logic 28 can realize the non-acoustic properties in the same or different facial features than those in which it realizes the acoustical properties. For example, in a cartoon character, hair is an easy indicator of sex.

And, by way of further example, the software/logic 28 can vary the overall coloration of the entire image or of the face itself, as well, based on non-acoustical (or, in some embodiments, acoustical) properties. Thus, in some embodiments, the software/logic 28 can add a bit of sepia (or other) tone or color (collectively, “color”) to the graphical depiction to represent the age of the song. The software/logic 28 can vary the color in accord with other information about the song, as well. This can include, for example, various phrases, such as the title of a song, artist name, or any well known entity.

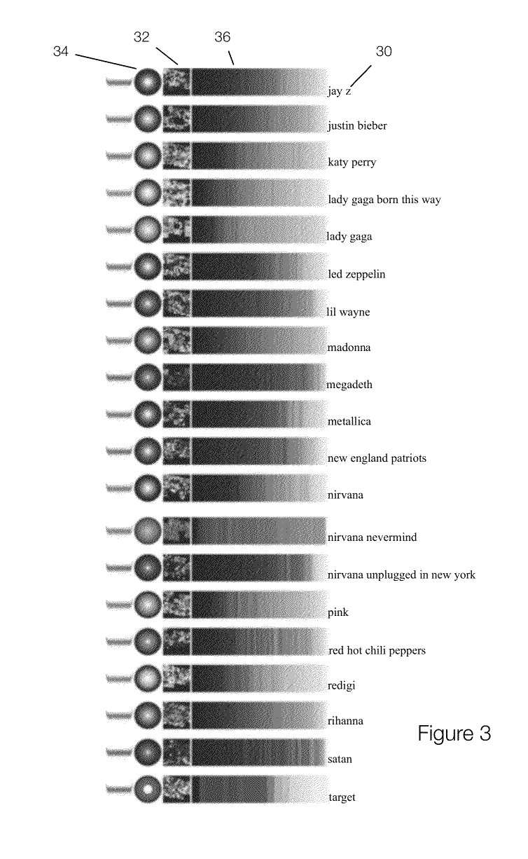

To further an appreciation of the latter point, FIG. 3 shows a black-and-white image converted from a color image showing various representations of the colors gathered from public web sites when given various words or phrases, such as the title of a song, artist name, or any well known entity. It can be seen that particular artists have colors that are pretty much associated with them. It is easy to distinguish the colors of very dissimilar songs. For each illustrated word or phrase 30, the colors are laid out three ways, a frequency map 32, and a spectral layout both as concentric circles 34 and horizontal lines 36.

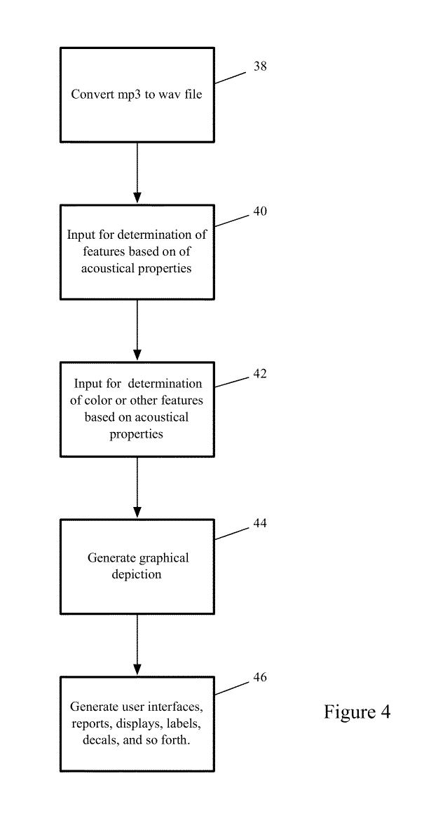

One exemplary methodology executed by software/logic 28 to generate a graphical depiction of a face from a music file is depicted in FIG. 4 and reprinted below:

| Step | Task |
|---|---|
| 38. | Convert MP3 to WAV file using ffmpeg. E.g. ffmpeg -i song.mp3 |
| | -y -ar 22050 -f s16be −> song.raw |
| 40. | Input the song.raw into software/logic 28 for analysis of |
| | acoustical properties, e.g., determination of the facial |
| | characteristics based on features from Table 1. |
| 42. | Input the metadata from the song file into software/logic 28 |
| | to determine associated colors and/or other facial features, |
| | e.g., as discussed above in connection with Table 2 and FIG. 3. |
| 44. | Execute software/logic 28 to generate face using features |
| | and colors from previous steps, e.g., as shown in FIG. 2. |

As those skilled in the art will appreciate Steps 40-42 of the illustrated embodiment provide for algorithmic generation of the “Chernoff” faces using techniques of the type ascribed thereto in book Computers, Pattern, Chaos and Beauty, by Clifford Pickover, and U.S. Pat. No. 7,089,504, “System and Method for Embodiment of Emotive Content in Modern Text Processing, Publishing and Communication,” the teachings of all of which are incorporated herein by reference, that algorithmically characterize the song.

In step 46, the software/logic 26 stores the face generated in step 44 and/or generates a graphical user interface with the face to facilitate identification and/or manipulation of the music file from which it was generated. Thus, for example, in step 46, software/logic 26 (executing on or in connection with one or more of those devices 12-22) can generate a graphical user interface that permit local and/or remote users to designate the music file
for purchase, sale, borrowing, lending, uploading, downloading, or other transfer.
to be viewed, listened-to, or otherwise “played” (e.g., by general- or special-purpose software and/or hardware tools' (not shown) executing on or in communications coupling with those respective devices, such as, for example, MP3 players, digital book readers, video players, digital image viewers, web browsers, and so forth);
to be accessed, manipulated, and/or managed,
   all by way of nonlimiting example. And, by way of further nonlimiting example, in step 46, the software/logic 26 can, instead or in addition, generate graphical reports for local or remote display, printout, or otherwise that itemize digital music file, e.g., for inventorying or other purposes. The software/logic 26 can, as well or in addition, in step 46, generate displays, labels, decals, and so forth for packaging and other physical or electronic displays pertaining to the creative works (or digital media objects).

### Sample Code

Sample code used in one embodiment of the invention for analysis of acoustical properties to determine facial characteristics in accord with Step 40 is provided in the Appendix and labelled FACE DRAWING.PY.

Sample python code used in one embodiment of the invention for analysis of metadata to determine color in accord with Step 42 follows. In this example, standard, publicly available images associated with the words or phrases (as determined, for example, by a Google search) are used to gather and determine the N most prominent colors in those images. Other properties of the music can be gathered and analyzed in a similar way, utilizing natural language processing techniques.

Conclusion with Discussion of Use of Life-Like Faces, By Way of Example

Described above and shown in the drawings are systems and apparatus operating in a manner that meets the objects set forth herein, among others. It will be appreciated that the embodiments here are mere examples of the invention, and that others employing changes hereto fall within the scope of the invention.

Thus, by way of nonlimiting example, although described above and depicted it in the drawings with cartoon faces, the software/logic 28 of other embodiments of the invention may generate graphical depictions of songs and their embodying music files (or other creative works and their respective digital media objects) using life-like faces. In this regard, the software/logic 28 can generate, for example, three (or more or less) versions of each feature—two extreme versions and one neutral, midlevel version. Based on the normalized and quantized values discussed above, for example, in connection with the discussion of FIG. 2, the software/logic 28 can employ morphing algorithms of the sort commercially or otherwise available in the marketplace to generate intermediate versions of those features, which can be assembled together to form a more lifelike face.

And, by way of further nonlimiting example, although the graphical depictions generated by software/logic 28 and reproduced, by software/logic 26, in user interfaces, reports, displays, labels, decals, and so forth, of the illustrated embodiment, are static images, in other embodiments they may be dynamic images.

1. A method of visually representing a song or digital media object embodying that song, comprising generating or otherwise providing (hereinafter, “generating”), with digital data apparatus, a graphical depiction of the song or digital media object, which graphical depiction algorithmically characterizes one or more properties of the song in an image of a living thing or portion thereof.

2. The method of claim 1, wherein the graphical depiction of a first said song or digital media object embodying that song is comparable in a visually perceptive manner with one or more other songs or digital media objects embodying them, which one or more other songs or digital media objects have one or more of said properties in common with the first said song or media object.

3. The method of claim 1, comprising generating, with the digital data apparatus, the graphical depiction such that it algorithmically characterizes one or more properties of the song in an image of an animal or portion thereof.

4. The method of claim 3, comprising generating, with the digital data apparatus, the graphical depiction such that it algorithmically characterizes one or more properties of the song in any of a cartoon or lifelike image of a face.

5. The method of claim 4, comprising generating, with the digital data apparatus, the graphical depiction utilizing Chernoff faces.

6. The method of claim 1, comprising generating, with the digital data apparatus, the graphical depiction such that each of multiple acoustic properties of the song algorithmically contribute to features of the graphical depiction.

7. The method of claim 6, comprising generating, with the digital data apparatus, the graphical depiction such that each of multiple acoustic properties of the song algorithmically contribute to features of an image of an animal or portion thereof.

8. The method of claim 7, comprising generating, with the digital data apparatus, the graphical depiction such that it algorithmically characterizes one or more properties of the song in any of a cartoon or lifelike image of a face.

9. The method of claim 8, comprising generating, with the digital data apparatus, the graphical depiction such that it algorithmically characterizes one or more properties of the song in a Chernoff face.

10. The method of claim 6, comprising generating, with the digital data apparatus, the graphical depiction wherein the multiple acoustical properties include any of: Energy Ratio, Tonality, Brightness, Energy Tempo, Energy Dry Run, Tonality dry run, Max Brightness, Quantized Tonality (largest Hold), Quantized Energy Ratio, Quantized Tonality, and Change Ratio.

11. The method of claim 10, comprising generating, with the digital data apparatus, the graphical depiction such that each of the multiple acoustic properties of the song contribute to each of one or more features of the living thing or portion thereof included in that depiction.

12. The method of claim 11, comprising generating, with the digital data apparatus, the graphical depiction such that each of the multiple acoustic properties of the song contribute to each of one or more features of a face included in that depiction.

13. The method of claim 12, comprising generating, with the digital data apparatus, the graphical depiction such that each of the multiple acoustic properties of the song contribute to each of one or more of the following features of the face included in that depiction: slant of the eyebrows, shape of the head, distance between the eyes, shape of the nose, color, ears, hair, cheeks, and eye color.

14. The method of claim 12, comprising generating, with the digital data apparatus, the graphical depiction such that each of the multiple acoustic properties of the song contribute to each of one or more of the following features of a Chernoff face included in that depiction: slant of the eyebrows, shape of the head, distance between the eyes, shape of the nose, color, ears, hair, cheeks, and eye color.

15. The method of claim 6, comprising generating, with the digital data apparatus, the graphical depiction such that one or more non-acoustical properties relating to the song algorithmically contribute to features of the graphical depiction.

16. The method of claim 15, comprising generating, with the digital data apparatus, the graphical depiction such that one or more non-acoustical properties relating to the song algorithmically contribute to features of an image of an animal or portion thereof.

17. The method of claim 16, comprising generating, with the digital data apparatus, the graphical depiction such that one or more non-acoustical properties relating to the song algorithmically contribute to features of an image of any of a cartoon or lifelike image of a face.

18. The method of claim 17, comprising generating, with the digital data apparatus, the graphical depiction such that one or more non-acoustical properties relating to the song algorithmically contribute to features of an image of any of a cartoon or lifelike image of a Chernoff face.

19. The method of claim 15, comprising generating, with the digital data apparatus, the graphical depiction wherein the non-acoustical properties include any of: Public Image(s) of Artist, Genre, Year or Age of Song, Sex of Recording Artist(s).

20. The method of claim 15, comprising generating, with the digital data apparatus, the graphical depiction such that one or more non-acoustical properties relating to the song algorithmically contribute to each of one or more features of a face included in that graphical depiction.

21-46. (canceled)
